(19) United States
(12) Patent Application Publication
(10) Pub. No.: US 2026/0371289 A1
(43) Pub. Date: Nov. 19, 2026

(54) COMMUNICATION METHOD AND APPARATUS, AND STORAGE MEDIUM

(71) Applicant: ZTE CORPORATION, Shenzhen, Guangdong (CN)

(72) Inventors: Yan WU, Shenzhen (CN); Fei XUE, Shenzhen (CN); Chenchen ZHANG, Shenzhen (CN); Mengzhen LI, Shenzhen (CN); Chuangxin JIANG, Shenzhen (CN); Huawei ZHAO, Shenzhen (CN)

(21) Appl. No.: 19/147,866

(22) PCT Filed: Jan. 3, 2024
(86) PCT No.: PCT/CN2024/070364

§ 371 Date: Jul. 14, 2025

(30) Foreign Application Priority Data
Feb. 1, 2023 (CN) 202310145919.9

(51) Int. Cl. H04W 64/00; H04W 76/15

(52) U.S. Cl. CPC H04W 64/00; H04W 76/15

(57) ABSTRACT

Disclosed are a communication method and apparatus, and a storage medium. The communication method is performed by a first communication node, and the method includes: determining a radio frequency chain identifier of a positioning reference signal, where the radio frequency chain identifier of the positioning reference signal is used to indicate a radio frequency chain used by the first communication node to transmit the positioning reference signal; and sending the radio frequency chain identifier of the positioning reference signal.

### CROSS-REFERENCE TO RELATED APPLICATION(S)

This application is a national phase entry under 35 USC 371 of International Patent Application No. PCT/CN2024/070364 filed on Jan. 3, 2024, the International Patent Application is filed based on Chinese Patent Application with the application No. 202310145919.9, filed on Feb. 1, 2023, and claims priority to the Chinese Patent Application, the entire contents of the International Patent Application and the Chinese Patent Application are incorporated herein by reference.

### TECHNICAL FIELD

The present disclosure relates to the field of communication technologies, and particularly, to a communication method and apparatus, and a storage medium.

### BACKGROUND

In the aspect of communication positioning, the 5G new radio (NR) network standard has inherent advantages, such as in aspects of large bandwidth, ultra-dense networking and large-scale antenna array, while the large-scale antenna array brings a measurement capability of signal angle observation information to the 5G network, thereby implementing an angle-based positioning method.

### SUMMARY

In an aspect, a communication method is provided. The communication method is performed by the first communication node, and includes: determining a radio frequency chain identifier of a positioning reference signal, where the radio frequency chain identifier of the positioning reference signal is used to indicate a radio frequency chain used by the first communication node to transmit the positioning reference signal; and sending the radio frequency chain identifier of the positioning reference signal.

In another aspect, another communication method is provided. The communication method is performed by a second communication node, and includes: acquiring radio frequency chain identifiers of a plurality of positioning reference signals, where a radio frequency chain identifier of each positioning reference signal of the plurality of positioning reference signals is used to indicate a radio frequency chain used by a first communication node to transmit the positioning reference signal; and determining whether to perform calibration processing on a group delay difference, according to the radio frequency chain identifiers of the plurality of positioning reference signals.

In yet another aspect, a communication apparatus is provided. The communication apparatus includes:
a determining module, configured to determine a radio frequency chain identifier of a positioning reference signal, where the radio frequency chain identifier of the positioning reference signal is used to indicate a radio frequency chain used by the first communication node to transmit the positioning reference signal; and
a sending module, configured to send the radio frequency chain identifier of the positioning reference signal.

In yet another aspect, another communication apparatus is provided. The communication apparatus includes:
an acquiring module, configured to acquire radio frequency chain identifiers of a plurality of positioning reference signals, where a radio frequency chain identifier of each positioning reference signal of the plurality of positioning reference signals is used to indicate a radio frequency chain used by a first communication node to transmit the positioning reference signal;
a determining module, configured to determine whether to perform calibration processing on a group delay difference according to the radio frequency chain identifiers of the plurality of positioning reference signals.

In yet another aspect, yet another communication apparatus is provided. The communication apparatus includes a processor, and the processor, when performing a computer program, implements the communication method described in any one of the above-mentioned aspects.

In yet another aspect, a computer-readable storage medium is provided. The computer-readable storage medium includes computer instructions; where the computer instructions, when executed, implement the communication method described in any one of the above-mentioned aspects.

In yet another aspect, a computer program product is provided, the computer program product includes computer program instructions, and the computer program instructions, when executed, implement the communication method described in any one of the above-mentioned aspects.

### BRIEF DESCRIPTION OF THE DRAWINGS

FIG. 1 is a schematic diagram of an architecture of a communication system according to some embodiments.

FIG. 2 is a schematic flowchart of a communication method according to some embodiments.

FIG. 3 is a structural schematic diagram of an MAC CE according to some embodiments.

FIG. 4 is a structural schematic diagram of another MAC CE according to some embodiments.

FIG. 5 is a schematic flowchart of another communication method according to some embodiments.

FIG. 6 is a structural schematic diagram of a first communication node according to some embodiments.

FIG. 7 is a structural schematic diagram of a second communication node according to some embodiments.

FIG. 8 is a structural schematic diagram of a communication apparatus according to some embodiments.

### DETAILED DESCRIPTION

To enable those skilled in the art to better understand the technical solutions of the embodiments of the present disclosure, the following will describe the technical solutions in the embodiments of the present disclosure clearly and completely, in conjunction with the drawings in the embodiments of the present disclosure. Obviously, the described embodiments are only a part of the embodiments of the present disclosure, not all of the embodiments. Based on the embodiments of the present disclosure, all other embodiments obtained by those ordinary skilled in the art without making inventive efforts fall within the scope of protection of the present disclosure.

In the description of the present disclosure, unless otherwise specified, the symbol “/” means “or”, and for example, A/B may represent A or B. Herein, “and/or” is only used to describe an associated relationship between associated objects, representing that there may be three relationships, and for example, A and/or B may represent three cases: only A, only B, and both A and B. Additionally, “at least one” means one or more, and “multiple/plurality of” means two or more. The words such as “first”, “second”, etc., do not limit the number and execution order, and the words such as “first”, “second”, etc., do not necessarily limit different terms.

It should be noted that in the present disclosure, the words such as “exemplary (exemplarily)” or “for example (such as, e.g.)”, etc., are used to represent examples, explanations, or illustrations. Any embodiment or design solution described with “exemplary (exemplarily)” or “for example (such as, e.g.)” in the present disclosure should not be interpreted as being more preferred or advantageous than other embodiments or design solutions. Specifically, the use of the words such as “exemplary (exemplarily)” or “for example (such as, e.g.)”, etc., is intended to present related concepts in a specific manner.

In the embodiments of the present disclosure, “indication” may include a direct indication and an indirect indication. For example, taking “first control information” as an example, the first control information may directly carry information A itself or an index of information A, to achieve the purpose of directly indicating information A. Alternatively, the first control information may also carry information B that has an associated relationship with information A, thereby achieving the purpose of indirectly indicating information A while indicating information B.

In a positioning process based on a positioning reference signal, the positioning process may be classified into the following three types according to different degrees of participation of the terminal and the network side: UE (user equipment)-based positioning, UE-assisted positioning and NW (Network)-based positioning.

UE-based positioning: the terminal is responsible for measuring a downlink positioning reference signal (DL-PRS) and calculating its own position information.

UE assisted positioning: the terminal is responsible for measuring a downlink positioning reference signal, and reports a measurement result to a location management function (LMF) entity, and the location management function entity calculates a position.

NW-based positioning: the terminal is responsible for sending an uplink positioning reference signal (UL-PRS), the base station performs measurement and reports a measurement result to a location management function entity, and the location management function entity calculates a position.

It can be understood that the positioning process may be classified into the following three types according to different positioning reference signals used in the positioning process: 1) a positioning process that relies on an uplink positioning reference signal; 2) a positioning process that relies on a downlink positioning reference signal; and 3) a positioning process that relies on both an uplink positioning reference signal and a downlink positioning reference signal.

With the rapid development of 5G networks, for the upgrading of the positioning method of the traditional long term evolution (LTE) technology network, the traditional observed time difference of arrival (OTDOA) technology is upgraded into an uplink time difference of arrival (UL-TDOA) technology and a downlink time difference of arrival (DL-TDOA) technology. Additionally, because the 5G network has a large-scale antenna array, the 5G network may implement angle-based positioning. Therefore, the following two angle-based positioning methods are added to the existing types of positioning methods: 1) an uplink signal arrival angle method: calculating the terminal's position, through measuring the angle of the uplink positioning reference signal by a plurality of base stations near the terminal, depending on base station antenna arrays; 2) a downlink signal departure angle method: calculating the terminal's position, by taking a beam direction of the departure of the downlink positioning reference signal as an angle between the terminal and the base station.

Capabilities involved in the above-mentioned different positioning methods are also different. In the positioning process with the terminal and the location management function entity, the location management function entity queries the capability of the terminal according to the used positioning method. Therefore, terminal measurement results corresponding to different positioning methods are different.

Exemplarily, in the positioning method using DL-TDOA, the corresponding measurement content is time difference of arrival of the downlink positioning reference signal (downlink reference signal time difference, DL RSTD) and reference signal receiving power of the downlink positioning reference signal (downlink positioning reference signal reference signal receiving power, DL PRS RSRP); and in the positioning method using the downlink signal departure angle (downlink angle of departure, DL-AOD, or DL-AoD), the corresponding measurement content is DL PRS RSRP; and in the positioning method using multi-round-trip ranging, the corresponding measurement content is DL PRS RSRP and a round-trip time (RTT) difference (UE Rx-Tx time difference) of the downlink positioning reference signal.

In addition, the 5G network also upgrades the uplink positioning reference signal and adds a configuration mode dedicated to positioning, so it is enabled that the uplink positioning reference signal may be sent at the maximum transmission power of the uplink signal, thereby ensuring the hearability of the signal, and improving the positioning capability of the uplink time difference of arrival technology.

With the support of the large-scale antenna array, in the positioning process, the positioning reference signal received by the receiving side may come from different radio frequency (RF) chains, and thus, when receiving the positioning reference signal, it is necessary to consider a group delay difference. For example, in the positioning process based on the upgraded uplink positioning reference signal, the terminal may select a radio frequency chain or a plurality of radio frequency chains to complete a transmission of the uplink positioning reference signal, thereby completing network coverage. However, different transmission modes of the uplink positioning reference signal will correspond to different group delay differences. An estimation error of the group delay difference by the base station or the location management function entity may reduce the accuracy of the positioning result.

Therefore, in order to enable the receiving side to know the use of the radio frequency chain and then improve the accuracy of positioning, how to report the radio frequency chain used in the process of transmitting the positioning reference signal to enable the receiving side to perform a reasonable hypothesis on the group delay difference, is an urgent problem to be solved.

The technical solutions provided in the embodiments of the present disclosure may be applied to various communication systems, such as a new radio communication system using the 5G communication technology, a future evolution system or a multi-communication fusion system, etc., which is not limited in the embodiments of the present disclosure.

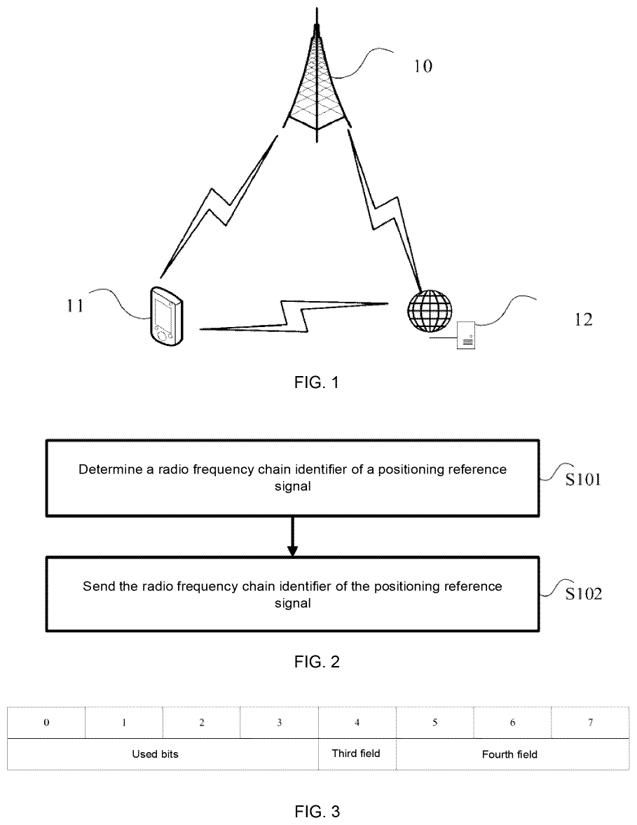

FIG. 1 is a structural schematic diagram of a communication system according to some embodiments. The communication system may include a base station 10, a terminal 11, and a location management function entity 12.

The base station 10 may be used to implement functions such as resource scheduling, radio resource management, and radio access control for the terminal 11, etc. In some embodiments, the base station may be any one of a small base station, a radio access point, a transmission/reception point (TRP), a transmission point (TP), or some other access nodes.

The terminal 11 may be a device with a function of a terminal. The terminal may also be referred to as a client, a user equipment (UE), a mobile station, or a mobile terminal, etc. The terminal may be a smartphone, a tablet computer, a computer with a wireless transceiving function, a virtual reality terminal, an augmented reality terminal, a wireless terminal in industrial control, a wireless terminal in autonomous driving, a wireless terminal in remote surgery, a wireless terminal for transportation safety, a wireless terminal in smart city, and a wireless terminal in smart home, etc. The embodiments of the present disclosure do not limit the device form used by the terminal.

The location management function entity 12 may be a location management function (LMF) network element, for providing a positioning service to the terminal. In future communications (such as 6G or other networks), the location management function entity may still be an LMF network element or have other names, which is not limited in the present disclosure.

It should be noted that the above-mentioned FIG. 1 is only an exemplary framework diagram, and the number of devices and the names of various devices included in the figure are not limited thereto, and in addition to the devices shown in the figure, the communication system may also include other devices, such as a core network device.

The application scenarios of the embodiments of the present disclosure are not limited thereto. The system architectures and service scenarios described in the embodiments of the present disclosure are intended to more clearly illustrate the technical solutions of the embodiments of the present disclosure, and do not constitute a limitation on the technical solutions provided in the embodiments of the present disclosure, and those ordinary skilled in the art may understand that with the evolution of network architectures and the emergence of new service scenarios, the technical solutions provided in the embodiments of the present disclosure are also applicable to similar technical problems.

Based on this, as shown in FIG. 2, the embodiments of the present disclosure provide a communication method. The communication method is performed by a first communication node, and includes the following S101 to S102.

S101: the first communication node determines a radio frequency chain identifier of a positioning reference signal.

Exemplarily, the first communication node may be a terminal or a base station, which is not limited thereto. The positioning reference signal may be an uplink positioning reference signal or a downlink positioning reference signal (DL-PRS), which is not limited thereto.

In some embodiments, the radio frequency chain identifier is used to identify a radio frequency chain. The radio frequency chain identifier may also be referred to as an index of the radio frequency chain, an indication of the radio frequency chain, or a number of the radio frequency chain, etc., which is not limited thereto. In some embodiments, different radio frequency chains of the first communication node have different radio frequency chain identifiers, so that other devices may distinguish the radio frequency chains used by the first communication node according to the radio frequency chain identifiers. In some embodiments, radio frequency chains of different communication nodes may be separately numbered, so that the radio frequency chains of different communication nodes may have the same radio frequency chain identifier(s). Alternatively, the radio frequency chains of different communication nodes may be jointly numbered, so that the radio frequency chains of different communication nodes have different radio frequency chain identifiers.

In some embodiments, the radio frequency chain identifier of the positioning reference signal may be used to indicate a radio frequency chain for transmitting the positioning reference signal. The transmitting may refer to sending or receiving.

Exemplarily, in the positioning process based on the downlink positioning reference signal, the terminal uses a radio frequency chain 1 to receive a downlink positioning reference signal 1, uses a radio frequency chain 2 to receive downlink positioning reference signal 2, and uses a radio frequency chain 3 to receive downlink positioning reference signal 3. Therefore, the terminal may determine that the radio frequency chain identifier of the downlink positioning reference signal 1 is the identifier of the radio frequency chain 1, the radio frequency chain identifier of the downlink positioning reference signal 2 is the identifier of the radio frequency chain 2, and the radio frequency chain identifier of the downlink positioning reference signal 3 is the identifier of the radio frequency chain 3.

In some embodiments, the first communication node may use a plurality of radio frequency chains to transmit a plurality of positioning reference signals. Alternatively, the first communication node may also use a same radio frequency chain to transmit a plurality of positioning reference signals. Therefore, the radio frequency chain identifiers of different positioning reference signals may be the same or may be different.

Exemplarily, in the positioning process based on the downlink positioning reference signal, the terminal uses a radio frequency chain 1 to receive a downlink positioning reference signal 1 and a downlink positioning reference signal 2, and uses a radio frequency chain 3 to receive a downlink positioning reference signal 3. Therefore, the terminal may determine that the radio frequency chain identifier of the downlink positioning reference signal 1 is the identifier of the radio frequency chain 1, the radio frequency chain identifier of the downlink positioning reference signal 2 is the identifier of the radio frequency chain 1, and the radio frequency chain identifier of the downlink positioning reference signal 3 is the identifier of the radio frequency chain 3.

S102: the first communication node sends the radio frequency chain identifier of the positioning reference signal.

In some embodiments, the radio frequency chain identifier of the positioning reference signal is sent by one of:
a radio resource control (RRC) signaling;
a media access control control element (MAC CE);
capability information;
a physical control channel.

The following describes the sending mode of the radio frequency chain identifier of the positioning reference signal.

### (1) RRC Signaling

The RRC signaling includes a first field and a second field.

The first field of the RRC signaling is used to indicate whether a signal transmission using a plurality of radio frequency chains is supported. For example, the first field is a first value, for indicating that the signal transmission using the plurality of radio frequency chains is supported; the first field is a second value, for indicating that the signal transmission using a radio frequency chain only is supported. Exemplarily, the first value and the second value of the first field of the RRC signaling are set as 1 and 0. When the first field of the RRC signaling is 1, it indicates that this positioning reference signal supports the use of a plurality of radio frequency chains for the transmission; and when the first field of the RRC signaling is 0, it indicates that this positioning reference signal only supports the use of a default radio frequency chain for the transmission.

The second field of the RRC signaling is used to record the radio frequency chain identifier of the positioning reference signal. It can be understood that only when the first field of the RRC signaling is the first value, the second field becomes valid. That is, only when a plurality of radio frequency chains are supported for the signal transmission, the second field in the RRC signaling becomes valid.

The number of bits occupied by the second field of the RRC signaling is related to the maximum number of radio frequency chains. In some embodiments, the second field of the RRC signaling records the radio frequency chain identifier of the positioning reference signal by an enumeration method; and the more radio frequency chains the positioning reference signal uses in the transmission process, the greater the number of bits occupied by the second field of the RRC signaling is. When the network allows the use of two radio frequency chains (RF chains) for the transmission, e.g., simultaneously completing signal transmissions in 700 MHz and 2 GHz frequency bands, the second field has values {0, 1}, where 0 indicates that the signal is sent by an RF chain 0, and 1 indicates that the signal is sent by an RF chain 1. When the network allows the use of up to N (N>2) RF chains for the transmission, the field has values {0, 1, 2, . . . , N−1}, where N−1 indicates that the signal is sent by an RF chain N−1.

In some embodiments, when a plurality of positioning reference signals are transmitted by a plurality of radio frequency chains, an RRC signaling may be sent to indicate the radio frequency chains for transmitting the positioning reference signals.

Exemplarily, when the terminal acquires its own position information, three positioning reference signals for indicating the position information of the terminal are transmitted by a radio frequency chain 3, a radio frequency chain 4, and a radio frequency chain 5. An RRC signaling may be sent to represent the radio frequency chain identifiers of these three positioning reference signals, and in this case, the value of the first field of the RRC signaling is 1, for representing that the transmission of the positioning reference signal using a plurality of radio frequency chains is supported in this positioning process; and the value of the second field of the RRC signaling is {3, 4, 5}, for representing that these three positioning reference signals are transmitted by the radio frequency chain 3, the radio frequency chain 4, and the radio frequency chain 5, respectively.

In some embodiments, the first field may also be referred to as a single-or-multi-RFchain field, and the second field may also be referred to as an RFchain-number field. The embodiments of the present disclosure do not limit the names of the first field and the second field.

### (2) MAC CE

In some embodiments, the MAC CE may include a third field and a fourth field.

The third field is used to indicate whether a signal transmission using a plurality of radio frequency chains is supported. For example, the third field is a third value, for indicating that the signal transmission using the plurality of radio frequency chains is supported; and the third field is a fourth value, for indicating that the signal transmission using a radio frequency chain only is supported. For example, only when the third field is the third value, the fourth field becomes valid.

The fourth field is used to record the radio frequency chain identifier of the positioning reference signal. The radio frequency chain identifier recorded in the fourth field of the MAC CE is the radio frequency chain identifier of the positioning reference signal corresponding to the MAC CE.

In some embodiments, in addition to the third field and the fourth field, the MAC CE may also include a fifth field, and the fifth field is used to indicate whether the signal transmission is signal reception or signal sending.

For example, the above-mentioned MAC CE may reuse an existing format of MAC CE. Typically, the existing format of MAC CE has 8 bits generally, where 4 bits are reserved bits. Therefore, the third field and the fourth field may be implemented by using part or all of the 4 reserved bits. As shown in FIG. 3, the third field occupies a reserved bit of the four reserved bits of the MAC CE, and the fourth field occupies three reserved bits of the four reserved bits of the MAC CE.

By way of example in conjunction with FIG. 3, the value of the third field is 1, for representing that the signal transmission using a plurality of radio frequency chains is supported in the process of transmitting the positioning reference signal; and the value of the fourth field is 011, for representing that the positioning reference signal corresponding to the MAC CE is transmitted by a radio frequency chain 3.

By way of example in conjunction with FIG. 3, the value of the third field is 0, for representing that the transmission only using a default radio frequency chain is supported in the process of transmitting the positioning reference signal.

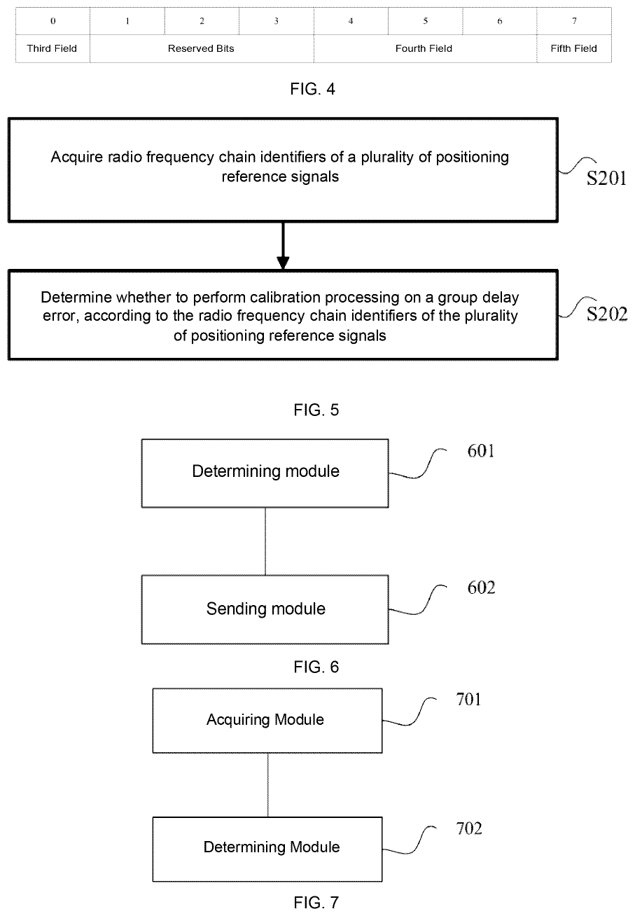

For another example, the above-mentioned MAC CE may be a new format of MAC CE. Therefore, part or all of 8 bits in the MAC CE may be used to implement the third field, the fourth field, and the fifth field. As shown in FIG. 4, the third field occupies a bit of the eight bits of the MAC CE, the fourth field occupies at least three bits of the eight bits of the MAC CE, and the fifth field occupies a bit of the eight bits of the MAC CE.

By way of example in conjunction with FIG. 4, the value of the third field is 1, for representing that the signal transmission using a plurality of radio frequency chains is supported in the process of transmitting the positioning reference signal; and the value of the fourth field is 1111, for representing that the positioning reference signal corresponding to the MAC CE is transmitted by a radio frequency chain 15; and the value of the fifth field is 0, for representing that a side for sending this MAC CE is the signal receiver.

By way of example in conjunction with FIG. 4, the value of the third field is 0, for representing that the signal transmission using a default radio frequency chain only is supported in the process of transmitting the positioning reference signal; and the value of the fifth field is 1, for representing that a side of sending this MAC CE is the signal receiver.

It should be noted that the embodiments of the present disclosure do not limit the positions of the third field, the fourth field, and the fifth field in the MAC CE, and the number of bits occupied by the third field, the fourth field, and the fifth field in the MAC CE.

In some embodiments, in a case where a plurality of positioning reference signals participate in the positioning process, the first communication node may send an MAC CE corresponding to each positioning reference signal of the plurality of positioning reference signals, to indicate the use of the radio frequency chain of the positioning reference signal.

Exemplarily, in the positioning process, three positioning reference signals are transmitted by a radio frequency chain 4, a radio frequency chain 5, and a radio frequency chain 6. Three MAC CE may be sent, to represent the radio frequency chain identifiers of the three positioning reference signals, respectively.

The value of the third field of an MAC CE1 corresponding to the positioning reference signal transmitted by the radio frequency chain 4 is 1, for representing that the signal transmission using the plurality of radio frequency chains is supported in the process of transmitting the positioning reference signal; the value of the fourth field of the MAC CE1 is 100, for representing that the positioning reference signal corresponding to the MAC CE1 is transmitted by the radio frequency chain 4; and the value of the fifth field of the MAC CE1 is 0, for representing a side for sending this MAC CE1 is the signal receiver.

The value of the third field of an MAC CE2 corresponding to the positioning reference signal transmitted by the radio frequency chain 5 is 1, for representing that the signal transmission using the plurality of radio frequency chains is supported in the process of transmitting the positioning reference signal; the value of the fourth field of the MAC CE2 is 101, for representing that the positioning reference signal corresponding to the MAC CE2 is transmitted by the radio frequency chain 5; and the value of the fifth field of the MAC CE2 is 0, for representing a side for sending this MAC CE2 is the signal receiver.

The value of the third field of an MAC CE3 corresponding to the positioning reference signal transmitted by the radio frequency chain 6 is 1, for representing that the signal transmission using the plurality of radio frequency chains is supported in the process of transmitting the positioning reference signal; the value of the fourth field of the MAC CE3 is 110, for representing that the positioning reference signal corresponding to the MAC CE3 is transmitted by the radio frequency chain 6; and the value of the fifth field of the MAC CE3 is 0, for representing a side for sending this MAC CE3 is the signal receiver.

### (3) Capability Information

The capability information includes a sixth field, and the sixth field is used to record the radio frequency chain identifier of the positioning reference signal.

When the sixth field of the capability information is a preset value, it indicates that the signal transmission using a radio frequency chain only is supported. Exemplarily, the preset value of the sixth field of the capability information is set as 0. When the sixth field of the capability information is 0, it represents that all positioning reference signals are transmitted by a default radio frequency chain only.

For another example, when the positioning reference signals are transmitted by using two or fewer radio frequency chains, the sixth field of the capability information occupies a bit to indicate a radio frequency chain used for transmitting the positioning reference signal corresponding to the capability information. For example, when the sixth field is 1, it represents that the positioning reference signal corresponding to the capability information is transmitted by a radio frequency chain 1.

In some embodiments, when the positioning reference signals are transmitted by using more than two radio frequency chains, the number of bits occupied by the sixth field of the capability information is related to a maximum number of radio frequency chains. The number X of bits occupied by the sixth field of the capability information and the maximum number N of radio frequency chains satisfy the following formula: X=log₂N.

Exemplarily, when the positioning reference signals are transmitted by 8 radio frequency chains, the sixth field of the capability information records the radio frequency chain identifiers of the positioning reference signals, by occupying three bits. For example, when the positioning reference signal is transmitted by a radio frequency chain 5, in this case, the value of the sixth field of the capability information corresponding to the positioning reference signal is 101, occupying three bits. For another example, when the positioning reference signal is transmitted by a radio frequency chain 7, the value of the sixth field of the capability information corresponding to the positioning reference signal is 111, occupying three bits.

In some embodiments, the sixth field may also be referred to as a RadioFrequencyChain-id field/information element, which is not limited in the embodiments of the present disclosure.

In some embodiments, when a plurality of positioning reference signals are transmitted by a plurality of radio frequency chains, capability information with a number same as the number of positioning reference signals may be sent, to indicate the radio frequency chains for transmitting the positioning reference signals. Exemplarily, when the terminal acquires its own position information, three positioning reference signals for indicating the position information of the terminal are transmitted by a radio frequency chain 5, a radio frequency chain 6, and a radio frequency chain 7. Three capability information may be sent, to represent radio frequency chain identifiers of the three positioning reference signals, respectively. The value of the sixth field of capability information 1 corresponding to the positioning reference signal transmitted by the radio frequency chain 5 is 101, for representing that the positioning reference signal corresponding to the capability information 1 is transmitted by the radio frequency chain 5. The value of the sixth field of capability information 2 corresponding to the positioning reference signal transmitted by the radio frequency chain 6 is 110, for representing that the positioning reference signal corresponding to the capability information 2 is transmitted by the radio frequency chain 6. The value of the sixth field of capability information 3 corresponding to the positioning reference signal transmitted by the radio frequency chain 7 is 111, for representing that the positioning reference signal corresponding to the capability information 3 is transmitted by the radio frequency chain 7.

### (4) Physical Control Channel

The physical control channel is a short physical control channel, such as a physical control channel with a physical uplink control channel (PUCCH) format 0 or a PUCCH format 2, to save the overhead of transmission resources.

In the embodiments of the present disclosure, the physical control channel is used to carry control information. The control information includes the radio frequency chain identifier of the positioning reference signal.

The physical control channel includes an uplink physical control channel and a downlink physical control channel. The control information carried by the uplink physical control channel is uplink control information, and the control information carried by the downlink physical control channel is downlink control information.

Exemplarily, when the terminal needs to acquire its own position information, the terminal, as the first communication node, after determining the radio frequency chain identifier of the positioning reference signal, sends uplink control information to the base station through the uplink physical control channel. This uplink control information represents that the positioning reference signals are transmitted by a radio frequency chain 1, a radio frequency chain 2, and a radio frequency chain 3 in the process of transmitting the positioning reference signals.

For another example, when the terminal needs to acquire its own position information, the base station, as the first communication node, after determining the radio frequency chain identifier of the positioning reference signal, and sends downlink control information to the terminal through the downlink physical control channel. The downlink control information represents that the positioning reference signals are transmitted by a radio frequency chain 0 only in the process of transmitting the positioning reference signals.

In some embodiments, when a plurality of positioning reference signals are transmitted by a plurality of radio frequency chains, a piece of control information may be sent through a physical control signal, to indicate the radio frequency chains for transmitting the positioning reference signals.

Exemplarily, when the terminal acquires its own position information, three positioning reference signals for indicating the position information of the terminal are transmitted by a radio frequency chain 3, a radio frequency chain 4, and a radio frequency chain 5. A piece of control information may be sent through the physical channel, to represent the radio frequency chain identifiers of the three positioning reference signals, and in this case, the control information represents that in this positioning process, the three positioning reference signals are transmitted by the radio frequency chain 3, the radio frequency chain 4, and the radio frequency chain 5, respectively.

In the embodiments of the present disclosure, the first communication node sends the radio frequency chain identifier of the positioning reference signal by means of the RRC signaling, the MAC CE, the capability information or the physical control channel, so that the second communication node participating in the positioning can know the use of the radio frequency chain of the first communication node, thereby improving the accuracy of the positioning.

As shown in FIG. 5, the embodiments of the present disclosure provide another communication method, which is applied to a second communication node, and the method includes the following S201 to S202.

S201: acquire radio frequency chain identifiers of a plurality of positioning reference signals.

Exemplarily, the second communication node may be a terminal, a base station, or a location management function entity, which is not limited thereto.

In some embodiments, in the positioning process with the participating of a terminal, a base station, and a location management function entity, the terminal, as the first communication node, determines radio frequency chain identifiers of a plurality of positioning reference signals, and sends the radio frequency chain identifiers of the plurality of positioning reference signals to the base station; the base station measures the radio frequency chain identifiers of the plurality of positioning reference signals and sends the measurement result and the radio frequency chain identifiers of the plurality of positioning reference signals to the location management function entity as the second communication node, so that the location management function entity acquires the radio frequency chain identifiers of the plurality of positioning reference signals to proceed with a next step of the positioning.

In some other embodiments, in the positioning process with the participating of the terminal and the location management function entity, the terminal, as the first communication node, determines radio frequency chain identifiers of a plurality of positioning reference signals, and measures the radio frequency chain identifiers of the plurality of positioning reference signals, and then sends the measurement result and the radio frequency chain identifiers of the plurality of positioning reference signals to the location management function entity as the second communication node, so that the location management function entity acquires the radio frequency chain identifiers of the plurality of positioning reference signals and proceed with a next step of the positioning.

In some other embodiments, in the positioning process with the participating of the terminal and the base station, the base station, as the first communication node, determines radio frequency chain identifiers of a plurality of positioning reference signals, and sends the radio frequency chain identifiers of the plurality of positioning reference signals to the terminal as the second communication node, so that the terminal acquires the radio frequency chain identifiers of the plurality of positioning reference signals and proceeds with a next step of the positioning.

S202: determine whether to perform calibration processing on a group delay difference, according to the radio frequency chain identifiers of the plurality of positioning reference signals.

The radio frequency chain identifier of the positioning reference signal is used to assist the second communication node to perform a group delay difference hypothesis.

It may be understood that when the plurality of positioning reference signals are transmitted by a same radio frequency chain, there is no group delay difference among the plurality of positioning reference signals; while the plurality of positioning reference signals are transmitted by different radio frequency chains, there is a group delay difference among the plurality of positioning reference signals. Therefore, the second communication node may determine whether to perform calibration processing on the group delay difference, based on whether the radio frequency chain identifiers of the plurality of positioning reference signals are the same.

In some embodiments, S202 may be implemented as: performing calibration processing on the group delay difference, in a case where the radio frequency chain identifiers of the plurality of positioning reference signals are different. For example, in the process of the calibration processing, the group delay difference is hypothesized according to a number of radio frequency chains used by the first communication node to transmit the positioning reference signals.

In some embodiments, S202 may be implemented as: determining not to perform calibration processing on the group delay difference, in a case where the radio frequency chain identifiers of the plurality of positioning reference signals are the same.

The technical solutions provided in the embodiments of the present disclosure are illustrated exemplarily below in conjunction with different positioning methods.

### (1) UE-Based Positioning

The base station sends a downlink positioning reference signal, and a sending-side radio frequency chain identifier corresponding to the downlink positioning reference signal.

The terminal measures the downlink positioning reference signal to obtain a measurement result. The terminal completes the calibration of the group delay difference and the calculation of the terminal position, according to the measurement result and the corresponding sending-side radio frequency chain identifier.

### (2) UE-Assisted Positioning

The base station sends a downlink positioning reference signal. The terminal measures the downlink positioning reference signal to obtain a measurement result, and determines a receiving-side radio frequency chain identifier corresponding to the measurement result (i.e., a receiving-side radio frequency chain identifier corresponding to the downlink positioning reference signal). The terminal sends the measurement result and the corresponding receiving-side radio frequency chain identifier to the location management function entity.

The location management function entity completes the calibration of the group delay difference and the calculation of the terminal position according to the measurement result and the corresponding receiving-side radio frequency chain identifier.

It needs to be noted that, due to different capabilities involved in different positioning methods, the location management function entity will specifically query the UE capability according to the positioning method to be used (the protocol does not rule out the possibility of using a plurality of positioning methods simultaneously, and the location management function entity may also request the terminal's capabilities related to a plurality of positioning methods simultaneously). Based on this, the measurement results corresponding to different downlink positioning methods may vary, as shown in Table 1.

TABLE 1

| Downlink positioning technology | Measurement content |
|---|---|
| DL-TDOA | DL RSTD |
| DL-TDOA, DL-AoD, Multi-RTT | DL PRS RSRP |
| Multi-RTT | UE Rx-Tx time difference |

### (3) NW-Based Positioning

The terminal sends a plurality of uplink positioning reference signals. Additionally, the terminal sends sending-side radio frequency chain identifiers of the plurality of uplink positioning reference signals, to the location management function entity.

The base station measures the uplink positioning reference signals to obtain the measurement result, and determines the receiving-side radio frequency chain identifier corresponding to the measurement result. The base station sends the measurement result and the corresponding receiving-side radio frequency chain identifier to the location management function entity.

The location management function entity completes the calibration of the group delay difference and the calculation of the terminal position according to the sending-side radio frequency chain identifier, the measurement result and the receiving-side radio frequency chain identifier.

It can be understood that, in order to implement the above-mentioned functions, a communication apparatus includes the corresponding hardware structures and/or software modules for performing the respective functions. Those skilled in the art should easily recognize that the present disclosure can be implemented in the form of hardware or a combination of hardware and computer software, in conjunction with the algorithmic steps of the respective examples described in the embodiments disclosed herein. Whether a certain function is performed by hardware or computer software-driven hardware depends on the specific application and design constraints of the technical solutions. Professional technicians may use different methods to implement the described functions, for each specific application, but such an implementation should not be considered beyond the scope of the present disclosure.

In the embodiments of the present disclosure, the communication apparatus may be divided into functional modules according to the above-mentioned method embodiments, and for example, each functional module may be divided corresponding to each function, or two or more functions may be integrated into one functional module. The above-mentioned integrated module may be implemented in the form of hardware or may be implemented in the form of software. It should be noted that the division of modules in the embodiments of the present disclosure is illustrative, and is merely a kind of logical functional division, and there may be other division methods in actual implementations. The example in which each functional module may be divided corresponding to each function is taken for explanation below.

FIG. 6 shows a structural schematic diagram of a first communication node provided in the embodiments of the present disclosure. As shown in FIG. 6, the first communication node includes a determining module 601 and a sending module 602.

The determining module 601 is configured to determine a radio frequency chain identifier of a positioning reference signal, where the radio frequency chain identifier of the positioning reference signal is used to indicate a radio frequency chain used by the first communication node to transmit the positioning reference signal.

The sending module 602 is configured to send the radio frequency chain identifier of the positioning reference signal.

In some embodiments, the radio frequency chain identifier of the positioning reference signal is used to assist the second communication node to perform a group delay difference hypothesis.

In some embodiments, the radio frequency chain identifier of the positioning reference signal is sent by one of: a radio resource control (RRC) signaling, a media access control control element (MAC CE), capability information, a physical control channel.

In some embodiments, the RRC signaling includes a first field and a second field, the first field is used to indicate whether a signal transmission using a plurality of radio frequency chains is supported, and the second field is used to record the radio frequency chain identifier of the positioning reference signal.

In some embodiments, the first field is a first value, for indicating that the signal transmission using the plurality of radio frequency chains is supported; the first field is a second value, for indicating that the signal transmission using a radio frequency chain only is supported.

In some embodiments, a number of bits occupied by the second field is related to a maximum number of radio frequency chains.

In some embodiments, the MAC CE includes a third field and a fourth field, the third field is used to indicate whether a signal transmission using a plurality of radio frequency chains is supported, and the fourth field is used to record the radio frequency chain identifier of the positioning reference signal.

In some embodiments, the MAC CE has four reserved bits, the third field occupies a reserved bit of the four reserved bits of the MAC CE, and the fourth field occupies three reserved bits of the four reserved bits of the MAC CE.

In some embodiments, the MAC CE further includes a fifth field, and the fifth field is used to indicate whether the signal transmission is signal reception or signal sending.

In some embodiments, the MAC CE has eight bits, the third field occupies a bit of the eight bits of the MAC CE, the fourth field occupies at least three bits of the eight bits of the MAC CE, and the fifth field occupies a bit of the eight bits of the MAC CE.

In some embodiments, the capability information includes a sixth field, and the sixth field is used to record the radio frequency chain identifier of the positioning reference signal.

In some embodiments, the sixth field is a preset value, for indicating that a signal transmission using a radio frequency chain only is supported.

In some embodiments, a number of bits occupied by the sixth field is related to a maximum number of radio frequency chains.

In some embodiments, the physical control channel is used to carry control information, and the control information includes the radio frequency chain identifier of the positioning reference signal.

In some embodiments, the physical control channel is a short physical control channel.

FIG. 7 shows a structural schematic diagram of a second communication node according to some embodiments. As shown in FIG. 7, the second communication node includes an acquiring module 701 and a determining module 702.

The acquiring module 701 is configured to acquire radio frequency chain identifiers of a plurality of positioning reference signals, where a radio frequency chain identifier of each positioning reference signal of the plurality of positioning reference signals is used to indicate a radio frequency chain used by a first communication node to transmit the positioning reference signal.

The determining module 702 is configured to determine whether to perform calibration processing on a group delay difference, according to the radio frequency chain identifiers of the plurality of positioning reference signals.

In some embodiments, the determining module 702 is configured to perform calibration processing on the group delay difference, in a case where the radio frequency chain identifiers of the plurality of positioning reference signals are different.

In some embodiments, the group delay difference is hypothesized according to a number of radio frequency chains used by the first communication node to transmit the positioning reference signals.

In some embodiments, the determining module 702 is configured to determine not to perform calibration processing on the group delay difference, in a case where the radio frequency chain identifiers of the plurality of positioning reference signals are the same.

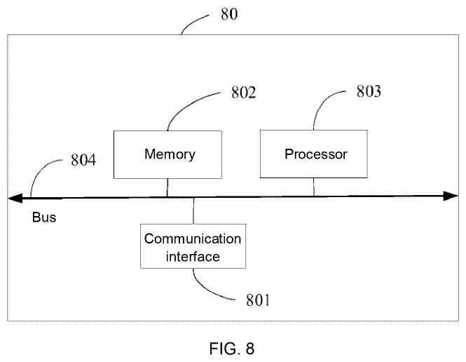

In the case of implementing the functions of the above-mentioned integrated modules in the form of hardware, the embodiments of the present disclosure provide a communication apparatus as shown in FIG. 8. As shown in FIG. 8, the communication apparatus 80 includes: a memory 801, a processor 802, a communication interface 803, and a bus 804.

The memory 801 may be, but not limited to, a read-only memory (ROM) or other types of static storage devices capable of storing static information and instructions, a random access memory (RAM) or other types of dynamic storage devices capable of storing information and instructions, or may also be an electrically erasable programmable read-only memory (EEPROM), a magnetic disk storage medium or other magnetic storage devices, or any other medium capable of being used to carry or store the desired program codes in the form of instructions or data structures and capable of being accessed by a computer.

The processor 802 may implement or perform the various exemplary logic blocks, modules, and circuits described in conjunction with the content disclosed in the present disclosure. The processor 802 may be a central processing unit, a general-purpose processor, a digital signal processor (DSP), a dedicated integrated circuit, a field-programmable gate array, or other programmable logic devices, transistor logic devices, hardware components, or any combination thereof. The processor 802 may implement or perform the various exemplary logic blocks, modules, and circuits described in conjunction with the content disclosed in the present disclosure. The processor 802 may also be a combination for implementing the computing functions, including, e.g., a combination of one or more microprocessors, a combination of a DSP and a microprocessor, etc.

The communication interface 803 is configured to connect with other devices through a communication network. The communication network may be Ethernet, radio access networks, or wireless local area networks (WLAN), etc.

In some embodiments, the memory 801 may exist independently of the processor 802, and the memory 801 may be connected to the processor 802 via the bus 804 and used for storing instructions or program codes. The processor 802, when calling and executing the instructions or program codes stored in the memory 801, is capable of implementing the communication method provided by the embodiments of the present disclosure.

In some embodiments, the memory 801 may also be integrated with the processor 802.

The bus 804 may be an extended industry standard architecture (EISA) bus or the like. Buses 804 may be divided into address buses, data buses, control buses, and the like. For the convenience of representation, only one thick line is used in FIG. 8 for representation, but it does not mean that there is only one bus or one type of bus.

Some embodiments of the present disclosure provide a computer-readable storage medium (e.g., a non-transitory computer-readable storage medium), and the computer-readable storage medium has stored computer program instructions therein that, when running on a computer, cause the computer to perform the method as described in any one of the above-mentioned embodiments.

Exemplarily, the above-mentioned computer-readable storage medium may include, but be not limited to, a magnetic storage device (e.g., a hard disk, a floppy disk or a magnetic tape, etc.), an optical disk (e.g., a compact disk (CD) or a digital versatile disk (DVD), etc.), a smart card and a flash memory device (e.g., an erasable programmable read-only memory (EPROM), a card, a stick or a key driver, etc.). The various computer-readable storage media described in the present disclosure may represent one or more devices and/or other machine-readable storage media for storing information. The term “machine-readable storage medium” may include, but not limited to, a radio channel and various other media capable of storing, containing, and/or carrying instructions and/or data.

The embodiments of the present disclosure provide a computer program product containing instructions, and the computer program product, when running on a computer, causes the computer to perform the method of any embodiment of the above embodiments.

The foregoing is only the specific implementations of the present disclosure, but the protection scope of the present disclosure is not limited thereto, and any changes or substitutions within the scope of the technologies disclosed in the present disclosure should be covered within the protection scope of the present disclosure. Therefore, the protection scope of the present disclosure should be based on the protection scope of claims.

What is claimed is:

1. A communication method, wherein the method is performed by a first communication node and comprises:
determining a radio frequency chain identifier of a positioning reference signal, wherein the radio frequency chain identifier of the positioning reference signal is used to indicate a radio frequency chain used by the first communication node to transmit the positioning reference signal; and
sending the radio frequency chain identifier of the positioning reference signal.

2. The method according to claim 1, wherein the radio frequency chain identifier of the positioning reference signal is used to assist the second communication node to perform a group delay difference hypothesis.

3. The method according to claim 1, wherein the radio frequency chain identifier of the positioning reference signal is sent by one of:
a radio resource control (RRC) signaling;
a media access control control element (MAC CE);
capability information;
a physical control channel.

4. The method according to claim 3, wherein the RRC signaling comprises a first field and a second field, the first field is used to indicate whether a signal transmission using a plurality of radio frequency chains is supported, and the second field is used to record the radio frequency chain identifier of the positioning reference signal; or
the MAC CE comprises a third field and a fourth field, the third field is used to indicate whether a signal transmission using a plurality of radio frequency chains is supported, and the fourth field is used to record the radio frequency chain identifier of the positioning reference signal; or
the capability information comprises a sixth field, and the sixth field is used to record the radio frequency chain identifier of the positioning reference signal; or
the physical control channel is used to carry control information, and the control information comprises the radio frequency chain identifier of the positioning reference signal.

5. The method according to claim 4, wherein
the first field is a first value, for indicating that the signal transmission using the plurality of radio frequency chains is supported;
the first field is a second value, for indicating that the signal transmission using a radio frequency chain only is supported.

6. The method according to claim 4, wherein a number of bits occupied by the second field is related to a maximum number of radio frequency chains.

7. (canceled)

8. The method according to claim 4, wherein the MAC CE has four reserved bits, the third field occupies a reserved bit of the four reserved bits of the MAC CE, and the fourth field occupies three reserved bits of the four reserved bits of the MAC CE.

9. The method according to claim 4, wherein the MAC CE further comprises a fifth field, and the fifth field is used to indicate whether the signal transmission is signal reception or signal sending.

10. The method according to claim 9, where the MAC CE has eight bits, the third field occupies a bit of the eight bits of the MAC CE, the fourth field occupies at least three bit of the eight bits of the MAC CE, and the fifth field occupies a bit of the eight bits of the MAC CE.

11. (canceled)

12. The method according to claim 4, wherein the sixth field is a preset value, for indicating that a signal transmission using a radio frequency chain only is supported.

13. The method according to claim 4, wherein a number of bits occupied by the sixth field is related to a maximum number of radio frequency chains.

14. (canceled)

15. The method according to claim 4, wherein the physical control channel is a short physical control channel.

16. A communication method, wherein the method is performed by a second communication node and comprises:
acquiring radio frequency chain identifiers of a plurality of positioning reference signals, wherein a radio frequency chain identifier of each positioning reference signal of the plurality of positioning reference signals is used to indicate a radio frequency chain used by a first communication node to transmit the positioning reference signal; and
determining whether to perform calibration processing on a group delay difference, according to the radio frequency chain identifiers of the plurality of positioning reference signals.

17. The method according to claim 16, wherein determining whether to perform calibration processing on the group delay difference, according to the radio frequency chain identifiers of the plurality of positioning reference signals, comprises:
performing calibration processing on the group delay difference, in a case where the radio frequency chain identifiers of the plurality of positioning reference signals are different.

18. The method according to claim 16, wherein the group delay difference is hypothesized according to a number of radio frequency chains used by the first communication node to transmit the positioning reference signals.

19. The method according to claim 16, wherein determining whether to perform calibration processing on the group delay difference, according to the radio frequency chain identifiers of the plurality of positioning reference signals, comprises:
determining not to perform calibration processing on the group delay difference, in a case where the radio frequency chain identifiers of the plurality of positioning reference signals are same.

20. A communication apparatus, comprising: a processor and a memory;
the memory stores instructions executable by the processor;
the processor is configured to, when performing the instructions, cause the communication apparatus to implement operations of:
determining a radio frequency chain identifier of a positioning reference signal, wherein the radio frequency chain identifier of the positioning reference signal is used to indicate a radio frequency chain used by the first communication node to transmit the positioning reference signal; and
sending the radio frequency chain identifier of the positioning reference signal.

21. A non-transitory computer-readable storage medium, wherein the computer-readable storage medium comprises computer instructions, and the computer instructions, when executed on a computer, cause the computer to perform the method according to claim 1.

22. A communication apparatus, comprising: a processor and a memory;
the memory stores instructions executable by the processor;
the processor is configured to, when performing the instructions, cause the communication apparatus to implement the method according to claim 16.

23. A non-transitory computer-readable storage medium, wherein the computer-readable storage medium comprises computer instructions, and the computer instructions, when executed on a computer, cause the computer to perform the method according to claim 16.
